(19) United States
(12) Patent Application Publication
(10) Pub. No.: US 2011/0210513 A1
(43) Pub. Date: Sep. 1, 2011

(54) NON-METALLIC BRUSH SEAL

(75) Inventors: Biao Fang, Clifton Park, NY (US); Christopher Edward Wolfe, Niskayuna, NY (US); Roderick Mark Lusted, Niskayuna, NY (US); Vasanth Srinivasa Kothnur, Clifton Park, NY (US); Eric John Ruggiero, Rensselaer, NY (US); Michael Alan Vallance, Loudonville, NY (US); Farshad Ghasripoor, Glenville, NY (US); Martin Soerensen, Naersnes (NO)

(73) Assignee: GENERAL ELECTRIC COMPANY, SCHENECTADY, NY (US)

(21) Appl. No.: 12/714,214

(22) Filed: Feb. 26, 2010

(51) Int. Cl. F16J 15/44

(52) U.S. Cl. 277/301; 277/355

(57) ABSTRACT

A rotary machine comprises a housing, a rotor that is rotatably disposed within the housing and having an axis about which the rotor may spin, and a seal disposed upon the housing. The seal comprises a support disposed on the housing and a plurality of flexible non-metallic bristles that extend from the housing and engage the rotor, such that the seal provides a barrier to fluid flow between a first region located in a first axial direction from the seal and a second region located in an opposite axial direction from the first region. The first region is filled with a bearing liquid and the second region is filled with a process fluid.

### BACKGROUND

The subject matter disclosed herein relates generally to a sealing system for an interface between rotating and stationary components and more particularly to a non-metallic brush seal.

In rotating machinery, several types of seals are used to minimize leakages. Seals may be provided between components in which a component moves relative to another component, for example, between a housing and a rotating shaft that rotates within the housing. A shaft is typically rotatable in one or more bearings fixed to the housing. The bearings may include a bearing cavity that will be sealed from external environment.

In some applications such as subsea pumps, to lubricate the bearing area, a bearing liquid can be used to enable proper hydrodynamic film development during operation. The bearing liquid supply is very limited and expensive due to the long tieback distance for the supply line. The process flow side can include heavy crude oil, gas, and corrosion and erosion elements. Seals can be used to prevent the flow of the bearing liquid to the process flow side. However, without proper sealing, the process flow can enter the bearing cavity and contaminate the bearings. Also, some seals may not be chemically compatible with the process flows. Chemical incompatibility can damage the seals and reduce sealing capability characteristics.

It would therefore be desirable to provide a seal that is chemically compatible with the process flow and prevents the bearings from being contaminated by the process flow.

### BRIEF DESCRIPTION

In accordance with one embodiment disclosed herein, a rotary machine comprises a housing, a rotor that is rotatably disposed within the housing and having an axis about which the rotor may spin, and a seal disposed upon the housing. The seal comprises a support disposed on the housing and a plurality of flexible non-metallic bristles that extend from the housing and engage the rotor, such that the seal provides a barrier to fluid flow between a first region located in a first axial direction from the seal and a second region located in an opposite axial direction from the first region. The first region is filled with a bearing liquid and the second region is filled with a process fluid.

In accordance with another embodiment disclosed herein, a seal assembly comprises a seal comprising a support disposed on the housing and a plurality of flexible non-metallic bristles that extend from the support and engage a rotor that is rotatably disposed within a housing, such that the seal provides a barrier to fluid flow between a first region located in a first axial direction from the seal and a second region located in an opposite axial direction from the first region. The first region is filled with a bearing liquid and the second region is filled with a process fluid.

In accordance with another embodiment disclosed herein, a method of operating a rotary machine comprises rotatably disposing a rotor along an axis of rotation within a housing, disposing a seal upon the housing, filling a first region of the housing with a bearing liquid, and filling a second region of the housing with a process fluid. The seal comprises a support disposed on the housing and a plurality of flexible non-metallic bristles that extend from the housing and engage the rotor. The first region is disposed in a first axial direction from the seal and the second region in the opposite axial direction from the first region of the housing.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a cross-sectional view of a rotary machine with brush seals in accordance with aspects disclosed herein.

FIG. 2 illustrates a side view of the rotary machine with a brush seal in accordance with aspects disclosed herein.

FIG. 3 illustrates an enlarged cross-sectional view of the brush seal at one end of the bearing cavity in accordance with aspects disclosed herein.

FIG. 4 illustrates a block diagram of a method of operating a rotary machine in accordance with aspects disclosed herein.

### DETAILED DESCRIPTION

Embodiments disclosed herein include a seal assembly for a rotary machine. The seal assembly is disposed between a rotor and a housing. The seal assembly includes a seal with flexible non-metallic bristles that engage the rotor. The seal acts as a barrier between a bearing liquid and a process fluid. As used herein, singular forms such as “a,” “an,” and “the” include plural referents unless the context clearly dictates otherwise.

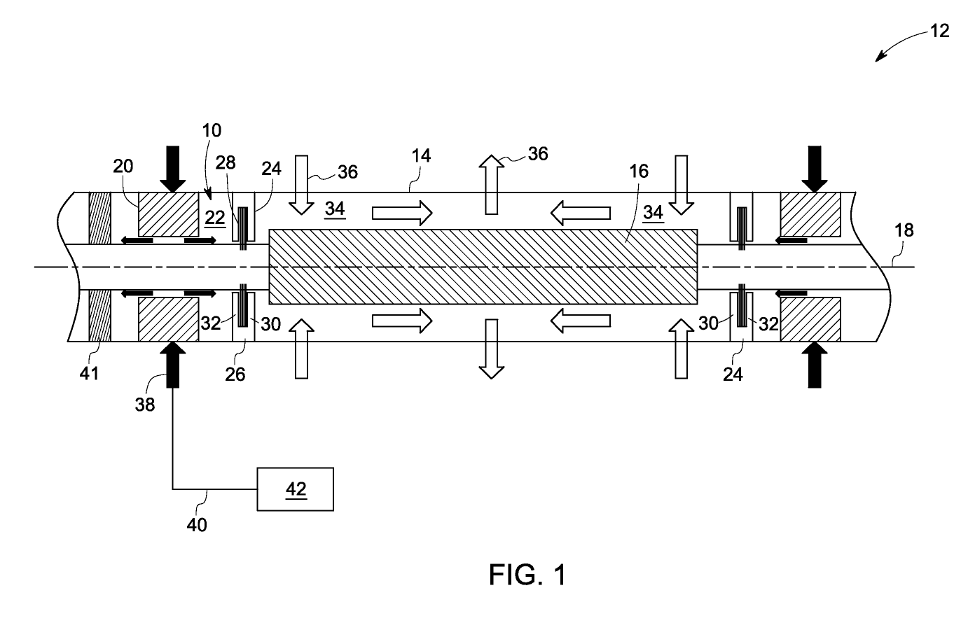

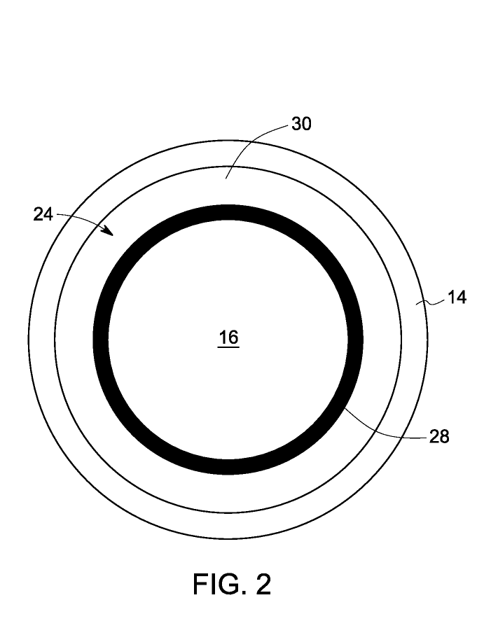

Referring to FIGS. 1 and 2, the seal assembly 10 is used with a rotary machine 12 such as a pump. The rotary machine 12 includes a housing 14 or a stator and a rotor 16 disposed within the housing 14. The rotor 16 rotates within the housing 14 along an axis 18 and is connected to a motor (not shown). Typically, a bearing 20 is attached to the housing 14 and the rotor 16 rotates in the bearing 20. A bearing cavity 22 is formed in the bearing area around the rotor 16. For some applications, the bearing cavity 22 can be filled with a lubricating liquid to enable smooth rotation of the rotor 16.

The seal assembly includes a brush seal 24 that is disposed about the rotor 16. The seal 24 includes a support 26, flexible non-metallic bristles 28, and opposing front plate 30 and back plate 32. The support 26, the front plate 30, and the back plate 32 are annular in order to conform to the rotor 16 and the housing 14. The non-metallic bristles 28 are attached to the support 26 and are disposed between the front plate 30 and the back plate 32. The bristles 28 extend radially beyond the front and back plates. A “radial” direction is a direction at any given point that is along a line extending perpendicularly from the axis 18 through the point. The support portion 26 of the seal 24 is attached to the housing 14 such that the non-metallic bristles 28 engage the rotor 16. There are a number of different ways of securing the bristles 28 into the brush seal. The non-metallic bristles 28 may be secured clamping between the front and back plates 30 and 32 or potting in an epoxy or a similar non-metallic matrix.

The seal 24 is disposed upon the housing 14 in a location such that a barrier is provided between a first region 22 located in a first axial direction from the seal 24 and a second region 34 located in an opposite axial direction from the first region. The first region is the bearing cavity 22. The second region 34 is the area that is external to the bearing 20 and exposed to or filled with the process flow 36 that is being delivered by the rotary machine 12. The second region 34 is separated from the first region 22 by the seal 24. The process flow 36 enters and exits the second region during operation of the rotary machine 12. The blocked arrows in the FIG. 1 represent an exemplary flow pattern of the process fluid in the second region 36.

Another seal 41 is provided on the other side of the bearing 20 that is not exposed to the process fluid. This seal 41 can be any type of seal such as, but not limited to, brush seal or labyrinth seal. The bearing cavity 22 is formed between this seal 41 and the brush seal 24.

The first region 22 is filled with a bearing liquid 38 to ensure proper hydrodynamic film development during operation. Clean liquids such as, for example, a water glycol mixture can be used as the bearing liquid 38. For subsea applications of the rotary machine 12, the bearing liquid 38 can be supplied via a supply line 40 from a remote location 42 such as a base station at the sea level. The shaded-blocked arrows in the FIG. 1 represent an exemplary flow pattern of the bearing liquid 38 in the first region 22. It is to be noted that the terminology of “front” plate 30 and the “back” plate 32 is relative to the bearing 20. The front plate 30 is the plate that is farther from the bearing 20 and the back plate 32 is the plate that is closer to the bearing 20.

The non-metallic bristles 28 can be made of aromatic polyamide (aramid) fibers, carbon fibers, Polyether Ether Ketone (PEEK) or other non-metallic materials that are chemically compatible with the bearing liquid 38 and the process fluid 36. In one embodiment, the non-metallic bristles can be made of para-aramid synthetic fiber such as KEVLAR® (trademark of DUPONT) or meta-aramid material such as NOMEX® (trademark of DUPONT).

In oil and gas industries, the process flows 36 delivered by the rotary machine can include multiphase flows, which consist of heavy crude oil, gases, and corrosive and erosive elements. Non-metallic fibers such as aramid and carbon fibers can tolerate oil, gases, corrosive elements, and erosive elements that are present in such multiphase flows. Non-metallic particulate that may result due to wear in non-metallic fibers, including aramid, PEEK, and carbon fibers, are benign in a bearing environment and do not jeopardize the life or operation of the bearings 20. Also, since the non-metallic bristles 28 are compliant, the seal 24 can tolerate large relative axial and radial motion between the rotor 16 and housing 14.

In other embodiments (not shown), the seal assembly can have multiple seals on each side of the bearing. The seal assembly 10 can also be used with other types of seals to further enhance sealing performance and ensure long-term reliability. For example, the seal 24 can be used in combination with a labyrinth seal.

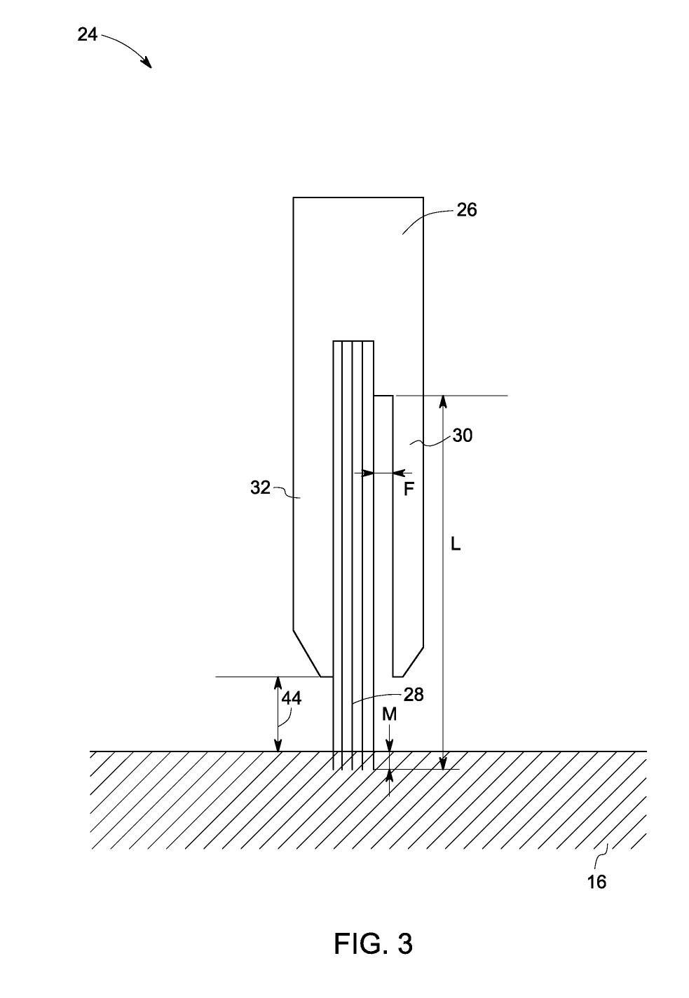

FIG. 3 illustrates a detailed cross-section view of the seal 24. The front plate 30 and back plate 32 maintain a clearance, called fence height 44, with respect to rotor. A portion of the front plate 30 is offset from the bristle pack by a distance ‘F’. This gap ‘F’ is important to make bristle pack flexible. This gap provides room for the bristles to move when the rotor moves in radial direction. The bristles 28 have a length ‘L’ from the support. The ends of the bristles 28 engage and interfere with the rotor 16. This interference length is denoted by ‘M.’

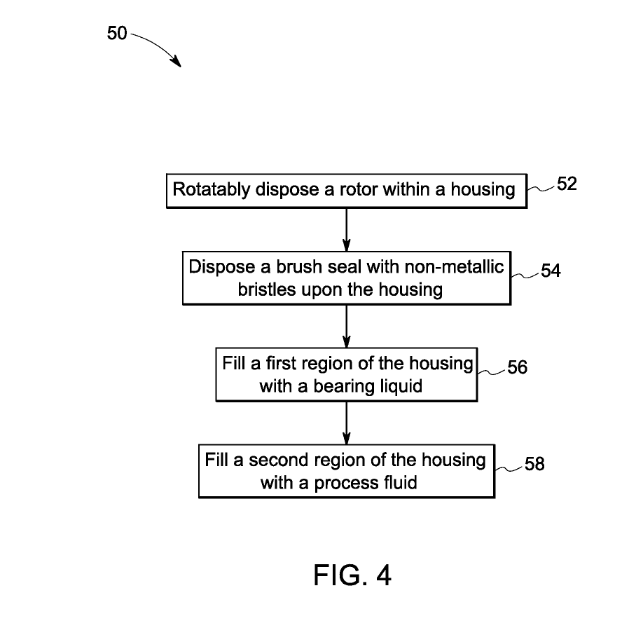

FIG. 4 illustrates a block diagram of a method 50 of operating a rotary machine. At block 52, a rotor is rotatably disposed along an axis of rotation within a housing. At block 54, a brush seal with non-metallic bristles is then disposed upon the housing. The seal comprises a support disposed on the housing and a plurality of flexible non-metallic bristles that extend from the housing and engage the rotor. At block 56, a first region of the housing is filled with a bearing liquid. The first region is in a first axial direction from the seal. At block 58, a second region of the housing is filled with a process fluid by the operation of the rotary machine. The second region is in the opposite axial direction from the first region of the housing.

The seal assembly described above thus provides a way to preserve the bearing liquid and keep the bearings from being contaminated by the process flow. The seal assembly provides a barrier between the bearing liquid in the bearing cavity and the process flow outside the bearing. For deep water or subsea applications, the bearing liquid supply can be limited and expensive due to the long tieback distance for the bearing liquid supply line. The non-metallic bristles provide a tight seal and prevent leakage of the bearing liquid, thereby preserving the bearing liquid.

The non-metallic brush seal 24 provides several benefits. The seal 24 is compact and, therefore, provides additional space that can be utilized in various ways. For example, additional space can be used for installing other components that are required for the rotary machine. Additional space can also be utilized for installing multiple brush seals in series without modifying the rotary machine. The seal does not require any additional cooling as in case of face seals. The brush seal can also be used in combination with other structures such as a sand shield plate, a lip seal, a labyrinth seal and/or a slinger. Such structures can be located adjacent to the brush seal along the axial direction of the rotor.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A rotary machine, comprising:
a housing;
a rotor that is rotatably disposed within the housing and having an axis about which the rotor may spin; and
a seal disposed upon the housing, the seal comprising a support disposed on the housing and a plurality of flexible non-metallic bristles that extend from the housing and engage the rotor, such that the seal provides a barrier to fluid flow between a first region located in a first axial direction from the seal and a second region located in an opposite axial direction from the first region;
wherein the first region is filled with a bearing liquid and wherein the second region is filled with a process fluid.

2. The rotary machine of claim 1, wherein the non-metallic bristles comprise bristles made with aramid, carbon fibers, Polyether Ether Ketone, or combinations thereof.

3. The rotary machine of claim 2, wherein the non-metallic bristles comprise para-aramid fibers.

4. The rotary machine of claim 2, wherein the non-metallic bristles comprises meta-aramid fibers.

5. The rotary machine of claim 1, wherein the non-metallic bristles are chemically compatible with the bearing liquid and the process fluid.

6. The rotary machine of claim 1, wherein the seal further includes a front plate and a back plate, with the non-metallic bristles disposed between the front plate and the back plate.

7. The rotary machine of claim 1, wherein the bearing liquid comprises glycol.

8. The rotary machine of claim 1, wherein the bearing liquid comprises a water-glycol mixture.

9. The rotary machine of claim 1, wherein the process fluid comprises a multiphase flow.

10. The rotary machine of claim 1, wherein the bearing liquid is a liquid used for lubricating a bearing in which the rotor rotates.

11. A seal assembly, comprising:
a seal comprising a support disposed on the housing and a plurality of flexible non-metallic bristles that extend from the support and engage a rotor that is rotatably disposed within a housing, such that the seal provides a barrier to fluid flow between a first region located in a first axial direction from the seal and a second region located in an opposite axial direction from the first region;
wherein the first region is filled with a bearing liquid and wherein the second region is filled with a process fluid.

12. The seal assembly of claim 11, wherein the non-metallic bristles comprise bristles made with aramid, carbon fibers, Polyether Ether Ketone, or combinations thereof.

13. The seal assembly of claim 11, wherein the non-metallic bristles are chemically compatible with the bearing liquid and the process fluid.

14. The seal assembly of claim 11, wherein the seal further includes a front plate and a back plate, with the non-metallic bristles disposed between the front plate and the back plate.

15. The seal assembly of claim 11, wherein the bearing liquid comprises glycol.

16. The seal assembly of claim 11, wherein the process fluid comprises a multiphase flow.

17. The seal assembly of claim 11, wherein the bearing liquid is a liquid used for lubricating a bearing in which the rotor rotates.

18. A method of operating a rotary machine, comprising:
rotatably disposing a rotor along an axis of rotation within a housing;
disposing a seal upon the housing, the seal comprising a support disposed on the housing and a plurality of flexible non-metallic bristles that extend from the housing and engage the rotor;
filling a first region of the housing, which is disposed in a first axial direction from the seal, with a bearing liquid; and
filling a second region of the housing, which is disposed in the opposite axial direction from the first region of the housing, with a process fluid.

19. The method of claim 18, wherein the non-metallic bristles comprise bristles made with aramid, carbon fibers, Polyether Ether Ketone, or combinations thereof.

20. The method of claim 18, wherein the non-metallic bristles are chemically compatible with the bearing and the process fluid.

21. The method of claim 18, wherein the bearing liquid comprises glycol.

22. The method of claim 18, wherein the process fluid comprises a multiphase flow.
